(19) United States
(12) Patent Application Publication
(10) Pub. No.: US 2026/0149664 A1
(43) Pub. Date: May 28, 2026

(54) METHOD FOR NETWORK CONNECTION BASED ON SCTP MULTI-HOMING AND ELECTRONIC DEVICE USING THE SAME

(71) Applicant: NetLOX Co., Ltd., Seoul (KR)

(72) Inventors: Seok Hwan KONG, Yongin-si (KR); Dipjyoti SAIKIA, Seongnam-si (KR); Nikhil MALIK, Seongnam-si (KR); Baek Gyun JUNG, Seongnam-si (KR); Ren Hao CHU, Seongnam-si (KR)

(73) Assignee: NetLOX Co., Ltd., Seoul (KR)

(21) Appl. No.: 18/962,238

(22) Filed: Nov. 27, 2024

(30) Foreign Application Priority Data
Nov. 25, 2024 (KR) 10-2024-0170091

(51) Int. Cl. H04L 47/125; H04L 47/19; H04L 61/256

(52) U.S. Cl. CPC H04L 47/125; H04L 47/19; H04L 61/256

(57) ABSTRACT

A method of an electronic device according to various exemplary embodiments may include: an operation of establishing SCTP connection through a first IP address via a client and a first external router and a second IP address via a second external router, an operation of translating the first IP address into a first IP translation address and the second IP address into a second IP translation address, and an operation of advertising the first IP translation address or the second IP translation address to an endpoint to control to perform SCTP data communication between the client and the endpoint. Other exemplary embodiments are also available.

### CROSS-REFERENCE TO RELATED APPLICATION

This present application claims the benefit of priority to Korean Patent Application No. KR 10-2024-0170091, filed on Nov. 25, 2024, in the Korean Intellectual Property Office, the entire disclosure of which is incorporated herein by reference.

### FIELD

Various exemplary embodiments of the present disclosure relate to a network connection method based on SCTP multi-homing and an electronic device using the same.

### BACKGROUND

In the 4th industrial revolution, which is a hot topic today, various types of data can be hyper-connected through various devices. In this environment, innovative convergence new products and service solution markets that reflect user's needs may expand, and for this, it may be necessary to build a network infrastructure that can process various data without loss.

### SUMMARY

The SCTP multi-homing provides reliability, load balancing, and seamless handover functions by utilizing multiple network connections and specifically may be useful in 5G and communication network (Telco network). A load balancing module according to the present disclosure may efficiently and seamlessly implement SCTP multi-homing by utilizing an extended Berkeley packet filter (eBPF)-based technique and play an important role in the cloud native architecture.

A method of an electronic device according to various exemplary embodiments may include: an operation of establishing SCTP connection through a first IP address via a client and a first external router and a second IP address via a second external router, an operation of translating the first IP address into a first IP translation address and the second IP address into a second IP translation address, and an operation of advertising the first IP translation address or the second IP translation address to an endpoint to control to perform SCTP data communication between the client and the endpoint.

An SCTP multi-homing system including a client, a first external router, a second external router, an electronic device, and an endpoint according to various exemplary embodiments may include an operation of establishing SCTP connection by the client and the electronic device through a first IP address via a first external router and a second IP address via a second external router, an operation of translating the first IP address into a first IP translation address and the second IP address into a second IP translation address, by the electronic device, an operation of advertising the first IP translation address or the second IP translation address to the client and the endpoint, by the electronic device, and an operation of performing SCTP data communication between the client and the endpoint.

According to various exemplary embodiments of the present disclosure, a load balancing module may improve the reliability by switching to various network paths so as not to cause a communication failure and optimally distribute traffics in various paths, perform communication without interruption during network switching, and control interoperability without significant changes in the existing network platform environment. The SCTP multi-homing-based network system may be constructed by means of such a load balancing module.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a block diagram of an electronic device in a network environment according to various exemplary embodiments of the present disclosure;

FIG. 2 is a block diagram of a program according to various exemplary embodiments of the present disclosure;

FIG. 3 is a view for an SCTP multi-homing system by means of a load balancing module according to various exemplary embodiments of the present disclosure;

FIG. 4 is a view schematically illustrating SCTP multi-homing when a load balancing module according to various exemplary embodiments of the present disclosure is a single node;

FIG. 5 is a view schematically illustrating SCTP multi-homing when a load balancing module according to various exemplary embodiments of the present disclosure is a cluster;

FIG. 6 is a view schematically illustrating an SCTP association establishment flow of a load balancing module according to various exemplary embodiments of the present disclosure;

FIG. 7 is a view schematically illustrating an SCTP traffic flow of a load balancing module according to various exemplary embodiments of the present disclosure through a primary service IP;

FIG. 8 is a view schematically illustrating an SCTP heartbeat message flow of a load balancing module according to various exemplary embodiments of the present disclosure; and

FIG. 9 is a view schematically illustrating an SCTP path failover flow of a load balancing module according to various exemplary embodiments of the present disclosure.

### DETAILED DESCRIPTION

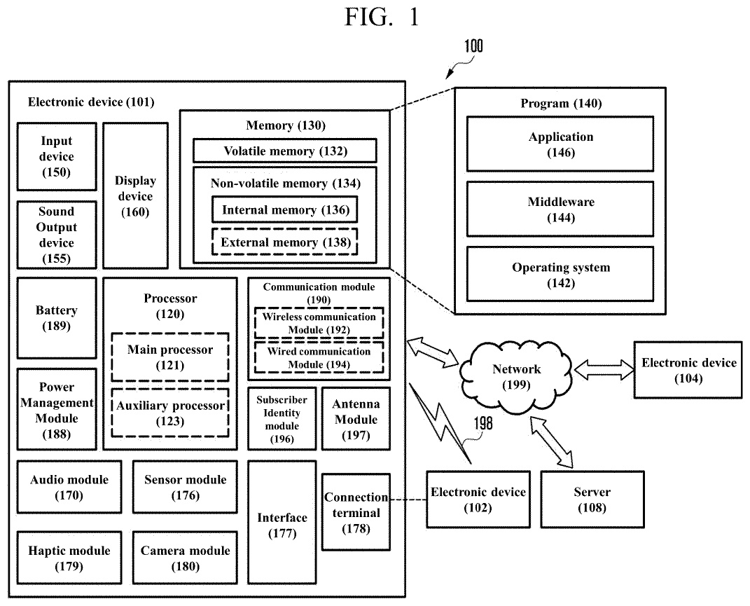

FIG. 1 is a block diagram of an electronic device 101 in a network environment 100, according to various exemplary embodiments. Referring to FIG. 1, in the network environment 100, the electronic device 101 may communicate with an electronic device 102 through a first network 198 (for example, a short-distance wireless communication network) or communicate with an electronic device 104 or a server 108 through a second network 199 (for example, a long-distance wireless communication network). According to an exemplary embodiment, the electronic device 101 may communicate with the electronic device 104 through a server 108. According to an exemplary embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, or an antenna module 197. In some exemplary embodiment, in the electronic device 101, at least one (for example, the display device 160 or the camera module 180) among the components may be omitted or one or more other components may be added. In some exemplary embodiment, some of the components may be implemented as one integrated circuit. For example, the sensor module 176 (for example, a fingerprint sensor, an iris sensor, or an illumination sensor) may be implemented to be embedded in the display device 160 (for example, a display).

For example, the processor 120 may execute software (for example, a program 140) to control at least one component (for example, hardware or software component) of the electronic device 101 connected to the processor 120 and perform various data processing or operations. According to the exemplary embodiment, as at least a part of the data processing or operations, the processor 120 may load commands or data received from another component (for example, the sensor module 176 or the communication module 190) in a volatile memory 132, process commands or data stored in the volatile memory 132, and store result data in a non-volatile memory 134. According to the exemplary embodiment, the processor 120 may include a main processor 121 (for example, a central processing unit or an application processor) and a coprocessor 123 (for example, a graphic processing device, an image signal processor, a sensor hub processor, or a communication processor) which operates independently or together. Additionally or alternatively, the coprocessor 123 may use a power lower than that of the main processor 121 or be set to be specified to a designated function. The coprocessor 123 may be implemented separately from the main processor 121 or as a part thereof.

The coprocessor 123 may control at least a part of functions or states related to at least one component (for example, the display device 160, the sensor module 176, or the communication module 190), among the components of the electronic device 101, instead of the main processor 121 when the main processor 121 is in an inactive (for example, a sleep) state or together with the main processor 121 when the main processor 121 is in an active (for example, application execution) state. According to the exemplary embodiment, the coprocessor 123 (for example, the image signal processor or the communication processor) may be implemented as a part of another functionally related component (for example, the camera module 180 or the communication module 190).

The memory 130 may store various data used by at least one component (for example, the processor 120 or the sensor module 176) of the electronic device 101. For example, the data may include software (for example, the program 140) and input data or output data about an instruction related thereto. The memory 130 may include the volatile memory 132 or the non-volatile memory 134.

The program 140 may be stored in the memory 130 as software, and for example, may include an operating system 142, a middleware 144, or an application 146.

The input device 150 may receive commands or data to be used in a component (for example, the processor 120) of the electronic device 101 from the outside (for example, a user) of the electronic device 101. For example, the input device 150 may include a microphone, a mouse, or a keyboard.

The sound output device 155 may output a sound signal to the outside of the electronic device 101. For example, the sound output device 155 may include a speaker or a receiver. The speaker may be used for general purposes, such as multimedia play or recording and the receiver may be used to receive incoming calls. According to the exemplary embodiment, the receiver may be implemented separately from the speaker or as a part thereof.

The display device 160 may visually provide information to the outside (for example, a user) of the electronic device 101. For example, the display device 160 may include a display, a hologram device, or a projector, and a control circuit for controlling the corresponding device. According to the exemplary embodiment, the display device 160 may include a touch circuitry set to sense the touch or a sensor circuitry (for example, a pressure sensor) set to measure strength of force generated by the touch.

The audio module 170 may convert a sound into an electrical signal or conversely, convert an electrical signal into a sound. According to the exemplary embodiment, the audio module 170 may acquire a sound through the input device 150 or output a sound through the sound output device 155 or an external electronic device (for example, the electronic device 102, for example, a speaker or a headphone) which is connected to the electronic device 101 directly or wirelessly.

The sensor module 176 may sense an operating state (for example, a power or a temperature) of the electronic device 101 or the external environment state (for example, a user state) and generate an electrical signal or a data value corresponding to the sensed state. According to the exemplary embodiment, the sensor module 170 may include, for example, a gesture sensor, a gyro sensor, a pressure sensor, a magnetic sensor, an acceleration sensor, a grip sensor, a proximity sensor, a color sensor, an IR (infrared) sensor, a biometric sensor, a temperature sensor, a humidity sensor, or an illumination sensor.

The interface 177 may support one or more designated protocols which are used to connect the electronic device 101 directly or wirelessly to the external electronic device (for example, the electronic device 102). According to the exemplary embodiment, the interface 177 may include a high definition multimedia interface (HDMI), a universal serial bus (USB) interface, an SD card interface, or an audio interface.

The connection terminal 178 may include a connector which allows the electronic device 101 to be physically connected to the external electronic device (for example, the electronic device 102) therethrough. According to the exemplary embodiment, the connection terminal 178 may include, for example, an HDMI connector, a USB connector, an SD card connector, or an audio connector (for example, a headphone connector).

The haptic module 179 may convert the electrical signal into mechanical stimulus (for example, a vibration or a motion) or an electrical stimulus which is perceived by the user through tactile or kinesthetic senses. According to the exemplary embodiment, the haptic module 179 may include, for example, a motor, a piezoelectric element, or an electrical stimulation device.

The camera module 180 may capture a still image and a motion image. According to the exemplary embodiment, the camera module 180 may include one or more lenses, image sensors, image signal processors, or flashes.

The power management module 188 may manage power which is supplied to the electronic device 101. According to the exemplary embodiment, the power management module 188 may be implemented, for example, as at least a part of a power management integrated circuit (PMIC).

The battery 189 may supply power to at least one component of the electronic device 101. According to the exemplary embodiment, for example, the battery 189 may include a non-rechargeable primary cell, a rechargeable secondary cell, or a fuel cell.

The communication module 190 may support establishment of a direct (for example, wired) communication channel or a wireless communication channel between the electronic device 101 and the external electronic device (for example, the electronic device 102, the electronic device 104 or the server 108) and the communication through the established communication channel. The communication module 190 may include one or more communication processors which are operated independently from the processor 120 (for example, the application processor) and support direct (for example, wired) communication or wireless communication. According to the exemplary embodiment, the communication module 190 may include the wireless communication module 192 (for example, a cellular communication module, a short distance wireless communication module, or a global navigation satellite system (GNSS) communication module) or the wired communication module 194 (for example, a local area network (LAN) communication module or a power line communication module). Among the communication modules, a corresponding communication module may communicate with the external electronic device through a first network 198 (for example, a short distance communication network, such as Bluetooth, Wi-Fi direct or infrared data association (IrDA)) or a second network 199 (for example, a long distance communication network, such as a cellular network, Internet, or a computer network (for example, LAN or WAN)). Various types of communication modules may be integrated as one component (for example, a single chip) or implemented as a plurality of separate components (for example, a plurality of chips). The wireless communication module 192 may identify or authenticate the electronic device 101 in the communication network, such as the first network 198 or the second network 199, using subscriber information (for example, international mobile subscriber identifier (IMSI)) stored in the subscriber identification module 196.

The antenna module 197 may transmit a signal or a power to the outside (for example, the external electronic device) or receive the signal or power from the outside. According to the exemplary embodiment, the antenna module 197 may include one or more antennas so that at least one antenna appropriate for a communication scheme used for the communication network, such as the first network 198 or the second network 199, may be selected, for example, by the communication module 190. The signal or the power may be transmitted or received between the communication module 190 and the external electronic device through at least one selected antenna.

At least some of the components may be connected to each other through a communication scheme (for example, a bus, general purpose input and output (GPIO), a serial peripheral interface (SPI), or mobile industry processor interface (MIPI)) between peripheral devices and exchange signals (for example, the commands or data) therebetween.

According to the exemplary embodiment, the commands or data may be transmitted or received between the electronic device 101 and the external electronic device 104, through the server 108 connected to the second network 199. Each of the electronic devices 102 and 104 may be the same type or different type of device as the electronic device 101. According to the exemplary embodiment, all or a part of the operations executed in the electronic device 101 may be executed in one or more external devices of the external electronic devices 102, 104, or 108. For example, when the electronic device 101 needs to perform an arbitrary function or service automatically or in response to the request of the user or another device, the electronic device 101 may request one or more external electronic devices to perform at least a part of the function or the service, instead of executing the function or the service by itself or additionally. One or more external electronic devices which receive the request may execute at least a part of the requested function or service or additional function or service related to the request and transmit the result of the execution to the electronic device 101. The electronic device 101 processes the result as it is or additionally to provide the result as at least a part of the response for the request. To this end, for example, cloud computing, distributed computing, or client-server computing technique may be used.

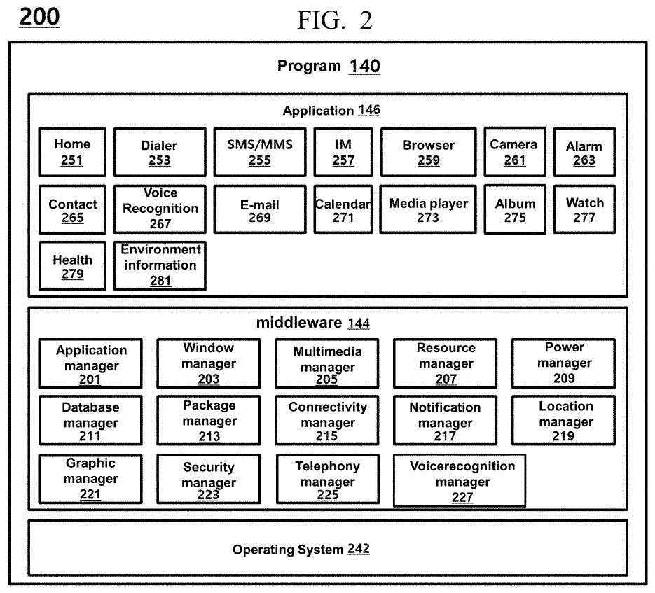

FIG. 2 is a block diagram 200 of a program 140 according to various exemplary embodiments. According to the exemplary embodiment, the program 140 may include an operating system 142 for controlling one or more resources of the electronic device 101, a middleware 144, or an application 146 which is executable on the operating system 142. For example, the operating system 142 may include Android™, iOS™, Windows™, Symbian™, Tizen™, or Bada™. For example, at least some program of the programs 140 may be preloaded in the electronic device 101 at the time of being manufactured or downloaded or updated from the external electronic device (for example, the electronic device 102 or 104 or the server 108) in the usage environment of the user.

The operating system 142 may control (for example, allocate or retrieve) a system resource (for example, a process, a memory, or a power source) of the electronic device 101. The operating system 142 may additionally or alternatively include one or more driver programs for driving another hardware device of the electronic device 101, for example, an input device 150, a sound output device 155, a display device 160, an audio module 170, a sensor module 176, an interface 177, a haptic module 179, a camera module 180, a power management module 188, a battery 189, a communication module 190, a subscriber identification module 196, or an antenna module 197.

The middleware 144 may provide various functions to the application 146 to allow the application 146 to use functions or information provided by one or more resources of the electronic device 101. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227. For example, the application manager 201 may manage a life cycle of the application 146. For example, the window manager 203 may manage a GUI resource used on a screen. For example, the multimedia manager 205 may identify a format required to play media files and encode or decode the media files using a codec suitable for the format. For example, the resource manager 207 may manage a source code of the application 146 or a space of the memory. For example, the power manager 209 may manage a capacity, a temperature, or a power of the battery and determine or provide power information required for the operation of the electronic device 101 using the corresponding information, among them. According to the exemplary embodiment, the power manager 209 may interwork with a basic input/output system (BIOS).

For example, the database manager 211 may generate, search, or change the database used for the application 146. For example, the package manager 213 may manage installation or updating of an application which is distributed in the form of a package file. For example, the connectivity manager 215 may manage wireless or wired connection between the electronic device 101 and the external electronic device. For example, the notification manager 217 may provide a function for notifying the user of an event (for example, calls, messages, or alarms) which has occurred. For example, the location manager 219 may manage location information of the electronic device 101. For example, the graphic manager 221 may manage a graphic effect to be provided to the user or a related user interface. For example, the security manager 223 may provide system security or user authentication. For example, the telephony manager 225 may manage voice call or video call function of the electronic device 101. For example, the voice recognition manager 227 may transmit voice data of the user to the server 108 and receive a command corresponding to a function to be performed in the electronic device 101 based on the voice data or text data converted based on the voice data. According to the exemplary embodiment, the middleware 244 may dynamically delete a part of existing components or add new components. According to the exemplary embodiment, at least a part of the middleware 144 may be included in a part of the operating system 142 or may be implemented as separate software from the operating system 142.

The application 146 may include, for example, a home 251, a dialer 253, SMS/MMS 255, an instant message (IM) 257, a browser 259, a camera 261, an alarm 263, a contact 265, voice recognition 267, e-mail 269, a calendar 271, a media player 273, album 275, watch 277, health 279 (for example, to measure an exercise amount or blood sugar), or environment information 281 (for example, pressure, humidity, or temperature information) applications. According to the exemplary embodiment, the application 146 may further include information exchange application (not illustrated) which supports information exchange between the electronic device 101 and the external electronic device. The information exchange application may include, for example, a notification relay application for transmitting designated information (for example, calls, messages, or alarms) to the external electronic device or a device management application for managing the external electronic device. For example, the notification relay application may transmit notification information corresponding to an event (for example, mail reception) occurring in another application (for example, an e-mail application 269) of the electronic device 101 or receive notification information from the external electronic device to provide the notification information to the user of the electronic device 101. The device management application may control the external electronic device which communicates with the electronic device 101 or a power (for example, turn-on or turn-off) of some components (for example, the display device 160 or the camera module 180), or a function (for example, a brightness, a resolution, or focus of the display device 160 or the camera module 180). The device management application may additionally or alternatively support installation, deletion, or updating of an application which operates in the external electronic device.

The electronic device according to various embodiments disclosed in the present document may be various types of devices. The electronic device may include, for example, a portable communication device (for example, smart phone), a computing device, a portable multimedia device, a portable medical instrument, a camera, a wearable device, or a home electronic device. The electronic device according to the embodiment of the present document is not limited to the above-described devices.

Exemplary embodiments of this document and terms used therein are not intended to limit the technical features described in the present document to specific embodiments, and should be understood to include various modifications, equivalents, or substitutes of the embodiments. With regard to the description of drawings, like reference numerals denote like or related components. The singular form of a noun corresponding to an item may include one or more of the above items, unless the relevant context clearly indicates otherwise. As used herein, each of the phrases such as “A or B”, “at least one of A and B”, “at least one of A or B”, “A, B or C”, “at least one of A, B and C”, and “at least one of A, B, or C” may include all possible combinations of the items listed together with the corresponding phrase. Terms such as “1st”, “2nd”, or “first” or “second” may be used simply to distinguish one element from another, but do not limit the components in another aspect (for example, importance or order). When one (for example, first) component is referred to as “coupled” or “connected” to another (for example, second) component, with or without the terms “functionally” or “communicatively”, it means that one component can be connected to the other component directly (for example. wired), wirelessly, or by means of a third component.

The term used in the document “module” may include a unit configured by hardware, software, or firmware and for example, may be exchangeably used with a term such as a logic, a logic block, a part, or a circuit. The module may be an integrally configured component, or a minimum unit of the component which performs one or more functions, or a part thereof. For example, according to an exemplary embodiment, the module may be implemented by an application-specific integrated circuit (ASIC).

Various exemplary embodiments of the present disclosure may be implemented as software (for example, a program 140) including one or more commands stored in a machine (for example, the electronic device 101) readable storage medium (for example, a built-in memory 136 or an external memory 138). For example, the processor (for example, processor 120) of the machine (for example, electronic device 101) may call at least one command, among one or more stored commands, from the storage medium and execute the command. This allows the machine to be operated to perform at least one function according to at least one called command. The one or more commands may include a code generated by a compiler or a code executable by an interpreter. Machine readable storage media may be provided as non-transitory storage media. Here, ‘non-transitory’ simply means that the storage medium is a tangible device and does not contain signals (e.g., electromagnetic waves), and the term does not distinguish between cases where data is stored semi-permanently or temporarily on the storage medium.

According to an exemplary embodiment, the method according to various exemplary embodiments disclosed in the present document may be provided to be included in a computer program product. The computer program product may be traded between sellers and buyers as commodities. The computer program products may be distributed in the form of machine readable storage media (for example, a compact disc read only memory (CD-ROM)) or may be distributed (for example, downloaded or uploaded) directly or online through an application store (for example, PlayStore^{TM}) or between two user devices (for example, smart phones). In the case of online distribution, at least some of computer program products may be temporarily stored in a machine readable storage medium such as a memory of a server of a manufacturer, a server of an application store, or a relay server or temporarily created.

According to various exemplary embodiments, each component (for example, a module or a program) of the above-described components may include a single entity or a plurality of entities. According to various exemplary embodiments, one or more components of the above-described components or operations may be omitted, or one or more other components or operations may be added. Alternatively or additionally, the plurality of components (or modules or programs) may be integrated as one component. In this case, the integrated component may perform one or more functions of each component of the plurality of components in the same or similar way to the function performed by the corresponding component of the plurality of components before being integrated. According to various exemplary embodiments, operations performed by a module, a program, or another component may be executed sequentially, in parallel, iteratively, or heuristically, or one or more of the operations may be executed in a different order or omitted or one or more other operations may be added.

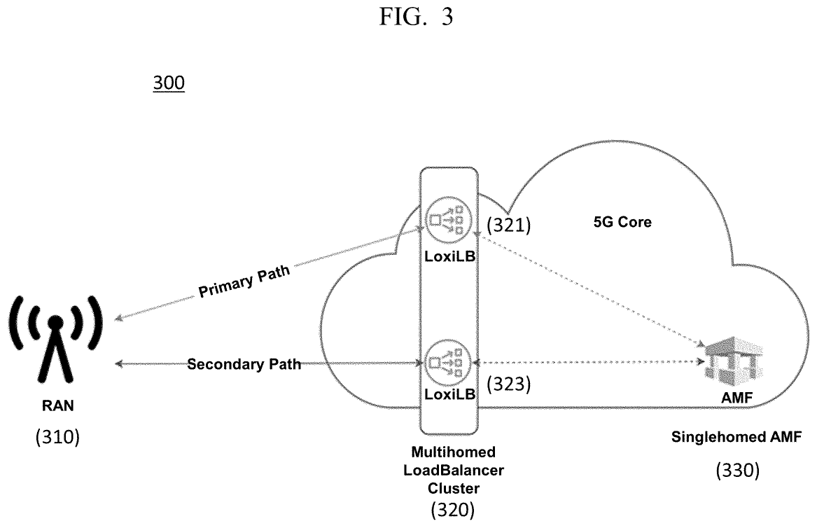

FIG. 3 is a view for an SCTP multi-homing system by means of a load balancing module according to various exemplary embodiments of the present disclosure.

According to various exemplary embodiments, referring to FIG. 3, an SCTP multi-homing system 300 through a load balancing module may include a radio access network (RAN) 310, a load balancing module 320, an access and mobility management function (AMF) 300. For example, the stream control transmission protocol (SCTP) is similar to TCP, but supports the multi-homing to provide high availability and load distribution function.

According to various exemplary embodiments, the RAN 310 may refer to an important network layer which manages wireless communication between the user device (for example, a smart phone or an IoT device) and a network core (for example, a 5G core) in a mobile communication network. The RAN 310 may receive a wireless signal through a base station and serve to connect the wireless signal to the load balancing module 320.

According to various exemplary embodiments, the load balancing module 320 may refer to a module which distributes a load applied to the cloud server. According to various exemplary embodiments, the load balancing module 320 includes a plurality of load balancers 321 and 323 to form a cluster to perform the operation. For example, the load balancing module 320 may synchronize packet connection information between load balancers and monitor each connection state to always maintain the connection state (high availability). For example, the load balancers 321 and 323 are located between the client and the cloud server to manage the traffic so as not to concentrate the load on one server to allow each server to show optimal performance.

According to various exemplary embodiments, the load balancing module 320 may perform multi-homed load balancing. For example, the load balancing module 320 distributes the network traffic through various network paths (that is, a plurality of IP addresses or network interfaces) to support the high availability and fault recovery.

According to various exemplary embodiments, the load balancing module 320 may configure a multi-homing load balancer on a Kubernetes (K8s) platform. For example, the Kubernetes is a platform which manages the cloud native application and does not support an advanced networking function, such as SCTP, as default, but may ensure high availability and fault tolerance of the SCTP connection on the Kubernetes platform through the load balancing module 320.

According to various exemplary embodiments, the load balancing module 320 operates in a full network address translation (FullNAT) mode so that even though multiple IP addresses are used, the SCTP packet may be smoothly translated and routed. For example, the FullNAT mode is one of network address translation (NAT) methods and specifically, may be used to effectively manage the IP addresses in a large-scale network and process the traffic. The load balancing module 320 may translate both a source (for example, client IP and port) and a destination (for example, server IP and port) in FullNAT mode, thereby providing a flexible and secure network connection.

According to various exemplary embodiments, the load balancing module 320 advertises a primary IP and a secondary IP through a border gateway protocol (BGP) to provide an optimal path. For example, the BGP may correspond to a protocol which exchanges routing information between networks. The load balancing module 320 connects numerous networks (AS: autonomous systems) on the Internet via BGP to allow data to be delivered through the optimal path.

According to various exemplary embodiments, the load balancing module 320 utilizes GoLang for control plane and extended Berkeley packet filter (eBPF) for data processing to be smoothly integrated with Kubernetes and replace the Kube-Proxy. For example, the load balancing module 320 may be configured by a Kubernetes combining agent, an eBPF-based data path, an integrated routing stack, and the like. For example, GoLang is a programming language developed by Google and is specified for high performance server or network applications and may be concise and excellent at parallel processing. For example, eBPF may correspond to a technique which allows a user space program in the Linux kernel to safely and efficiently directly execute the codes in the kernel.

According to various exemplary embodiments, the load balancing module 320 may set multi-homing. For example, the load balancing module 320 may set primary and secondary IPs to the SCTP service by means of the Kubernetes service annotation.

According to various exemplary embodiments, the load balancing module 320 may manage the heartbeat and failover. For example, the load balancing module 320 may receive a heartbeat message to confirm a path availability from the SCTP endpoint and control failover to the secondary path when a problem occurs in the primary path.

According to various exemplary embodiments, the load balancing module 320 may configure the SCTP multi-homing through Kubernetes manifest and define the primary IP, the secondary IP, the endpoint, the operation mode, and the like through the service rules.

According to various exemplary embodiments, the AMF 330 may correspond to single-homed AMF and it may mean that AMF, one of core elements of the 5G network is connected to only one network path (or IP address). For example, the single-homed indicates a single path of the network connection and may be distinguished from the multi-homed which supports multi-path connection.

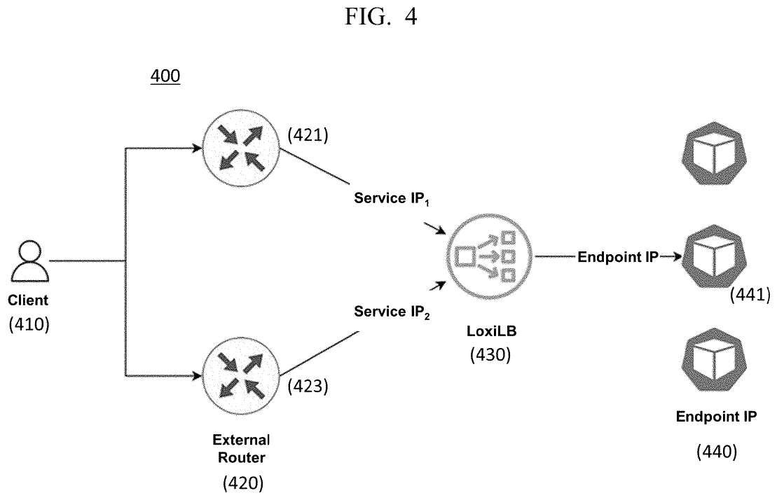

FIG. 4 is a view schematically illustrating SCTP multi-homing when a load balancing module according to various exemplary embodiments of the present disclosure is a single node.

According to various exemplary embodiments, referring to FIG. 4, a client 410 may be connected to a load balancing module 430 which is a single node, through an external router 420. The load balancing module 430 may provide network connection between the client 410 and the endpoint 440.

According to various exemplary embodiments, the client 410 may be connected to the load balancing module 430 through a first external router 421 or a second external router 423. For example, the first external router 421 may be connected to the load balancing module 430 through a first IP address and the second external router 423 may be connected to the load balancing module 430 through a second IP address. That is, even though the load balancing module 430 is a single node, the load balancing module may perform the SCTP multi-homing based on a plurality of IP addresses (for example, a service IP1 and a service IP2). The load balancing module 430 may provide flexible and stable network connection with the client 410 and an endpoint 441 through the endpoint IP, regardless of an external router 420 through which the client 410 accesses.

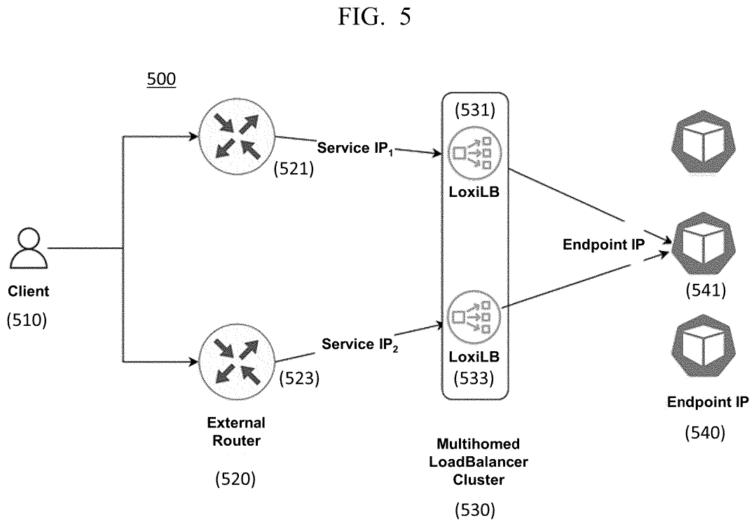

FIG. 5 is a view schematically illustrating SCTP multi-homing when a load balancing module according to various exemplary embodiments of the present disclosure is a cluster.

According to various exemplary embodiments, referring to FIG. 5, a client 510 may be connected to a load balancing module 530 which configures a load balancer cluster, through an external router 520. The load balancing module 530 may provide network connection between the client 510 and the endpoint 540.

According to various exemplary embodiments, the client 510 may be connected to the load balancing module 530 through a first external router 521 or a second external router 523. For example, the first external router 521 may be connected to a first load balancer 531 through a first IP address and the second external router 523 may be connected to a second load balancer 533 through a second IP address. That is, the load balancing module 530 may correspond to clusters of the plurality of load balancers 531 and 533 and perform the SCTP multi-homing based on the plurality of IP addresses (for example, a service IP1 and a service IP2). The load balancing module 530 may provide flexible and stable network connection with the client 510 and an endpoint 541 through the endpoint IP, regardless of an external router 520 through which the client 510 accesses.

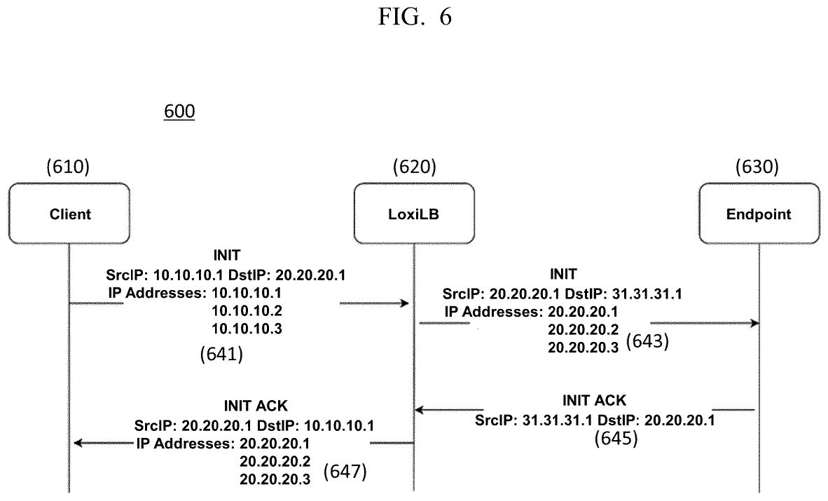

FIG. 6 is a view schematically illustrating SCTP association establishment flow of a load balancing module according to various exemplary embodiments of the present disclosure.

According to various exemplary embodiments, the load balancing module 620 may transmit a SCTP packet between the client 610 and the endpoint 630 based on the SCTP association establishment in the FullNAT mode.

According to various exemplary embodiments, in an operation 641, the client 610 may transmit an INIT message to the load balancing module 620. For example, the INIT message may include a source address (src IP), a destination address (dst IP), and a plurality of IP addresses which is available for the client.

According to various exemplary embodiments, in an operation 643, the load balancing module 620 may transmit the INIT message to the endpoint 630. For example, the load balancing module 620 translates the IP of the client 610 to transmit the IP to the endpoint 630. If the load balancing module 620 translates the src IP, instead of the original IP of the client 610, to transmit the translated src IP to the endpoint 630, the endpoint 630 does not know the original IP of the client 610, which may help to enhance the security.

According to various exemplary embodiments, in an operation 645, the endpoint 630 may transmit INIT ACK message to the load balancing module 620 and in an operation 647, the load balancing module 620 transmits the INT ACK message to the client 610 to notify the establishment of the SCTP connection of the endpoint 630.

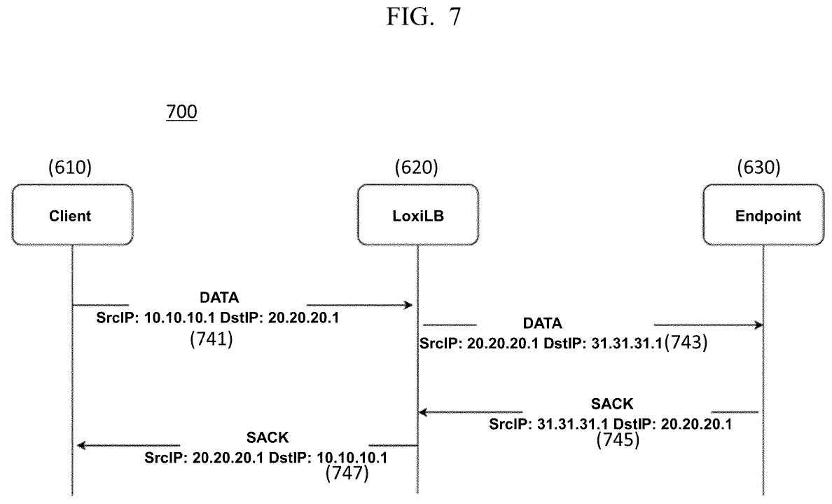

FIG. 7 is a view schematically illustrating an SCTP traffic flow of a load balancing module according to various exemplary embodiments of the present disclosure through a primary service IP.

According to various exemplary embodiments, the load balancing module 620 may transmit an SCTP packet between the client 610 and the endpoint 630 through the primary service IP based on the SCTP association establishment in the FullNAT mode.

According to various exemplary embodiments, in an operation 741, the client 610 may transmit a DATA message to the load balancing module 620. For example, the client 610 may transmit the DATA message to the load balancing module 620 using primary service IPs (for example, src IP(10.10.10.1) and dst IP(20.20.20.1) set through the connection establishment of FIG. 6.

According to various exemplary embodiments, in an operation 743, the load balancing module 620 may transmit the DATA message to the endpoint 630. For example, the load balancing module 620 may transmit the DATA message to the endpoint 630 using primary service IPs (for example, src IP(20.20.20.1) and dst IP(31.31.31.1) set through the connection establishment of FIG. 6.

According to various exemplary embodiments, in an operation 745, the endpoint 630 may transmit a SACK message to the load balancing module 620 and in an operation 747, the load balancing module 620 may transmit the SACK message to the client 610 to notify that the SCTP traffic has been processed.

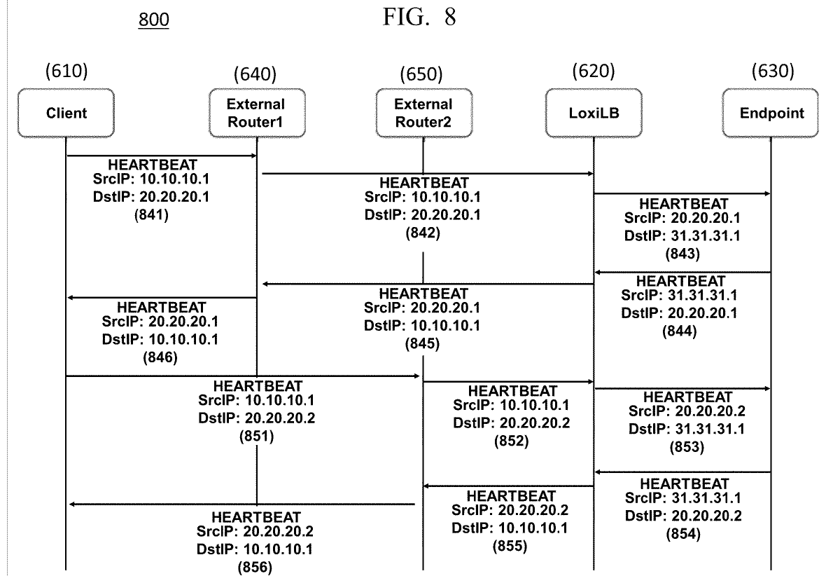

FIG. 8 is a view schematically illustrating an SCTP heartbeat message flow of a load balancing module according to various exemplary embodiments of the present disclosure.

According to various exemplary embodiments, referring to FIG. 8, the load balancing module 620 may exchange a heartbeat message in the SCTP multi-homing environment. The load balancing module 620 may exchange the heartbeat message to periodically check the connection state with the network device or the server. By doing this, the load balancing module 620 identifies whether the connection is normal or a network path is still effective to maintain the high availability and the stability of the network environment.

According to various exemplary embodiments, the load balancing module 620 may exchange the heartbeat message with the client 610, the first external router 640, and the endpoint 630 through operations 841, 842, 843, 844, 845, and 846. By doing this, the load balancing module 620 may sense whether to maintain network connection with the first external router 640 device to normally operate. For example, when the multi-homing SCTP connection is performed by means of the first external router 640, the load balancing module 620 may use the first service IP(20.20.20.1).

According to various exemplary embodiments, the load balancing module 620 may exchange the heartbeat message with the client 610, the second external router 650, and the endpoint 630 through operations 851, 852, 853, 854, 855, and 856. By doing this, the load balancing module 620 may sense whether to maintain network connection with the second external router 650 device to normally operate. For example, when the multi-homing SCTP connection is performed by means of the second external router 650, the load balancing module 620 may use the second service IP(20.20.20.2).

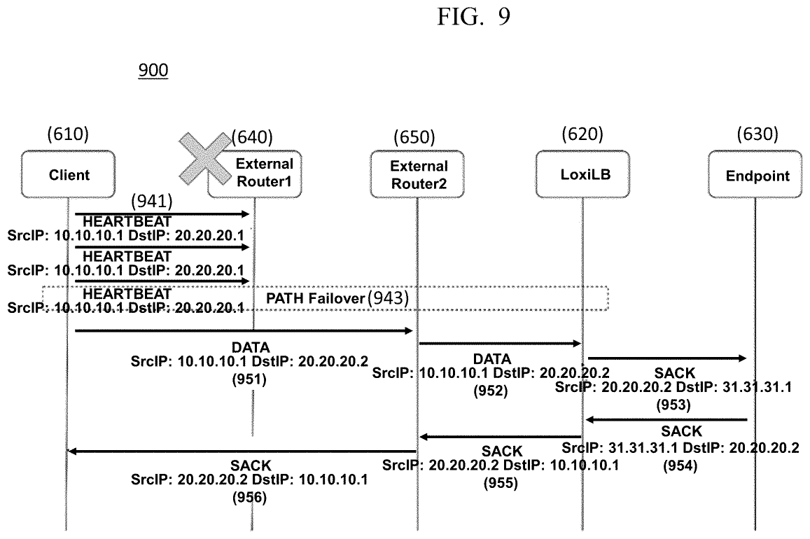

FIG. 9 is a view schematically illustrating an SCTP path failover flow of a load balancing module according to various exemplary embodiments of the present disclosure.

According to various exemplary embodiments, referring to FIG. 9, when a plurality of IP paths is connected, the load balancing module 620 may identify a state of each path through the heartbeat message and when there is a failure, switch the path to another path.

According to various exemplary embodiments, in an operation 941, the client 610 periodically transmits the heartbeat message to the first external router 640, but may not receive any ACK message.

According to various exemplary embodiments, in an operation 943, the load balancing module 620 may sense the failure of the first external router 640 and perform the path failover to the second external router 650.

According to various exemplary embodiments, the load balancing module 620 supports the SCTP network connection with the client 610, the second external router 650, and the endpoint 630 through operations 951, 952, 953, 954, 955, and 956 to control to transmit and receive data therebetween. That is, the SCTP endpoint 630 sends a heartbeat message to identify the path availability and the load balancing module 620 manages it to perform the failover to the secondary path when there is a problem in the primary path.

According to various exemplary embodiments, when the failure occurs, the load balancing module switches to an alternative path to consistently maintain the connection so that the reliability may be improved.

According to various exemplary embodiments, the load balancing module distributes the traffic to various paths to perform the load distribution to optimize the resource utilization.

According to various exemplary embodiments, the load balancing module supports the seamless communication during the network switching to perform smooth handover.

According to various exemplary embodiments, the load balancing module is easily integrated with a platform, such as Kubernetes, to be applied without causing a big change on the existing workflow so that the cloud native compatibility may be excellent.

According to various exemplary embodiments, a Kubernetes combination agent is installed in the Kubernetes cluster and the Kubernetes manifest is used to define the primary IP and the secondary IP addresses of the SCTP service. Further, the load balancing module and the service endpoint status are checked by means of the Kubernetes command and the command line tool of the load balancing module to use the load balancing module.

A method of an electronic device according to various exemplary embodiments may include: an operation of establishing SCTP connection through a first IP address via a client and a first external router and a second IP address via a second external router, an operation of translating the first IP address into a first IP translation address and the second IP address into a second IP translation address, and an operation of advertising the first IP translation address or the second IP translation address to an endpoint to control to perform SCTP data communication between the client and the endpoint.

The electronic device may include an operation of receiving a first heartbeat message and a second heartbeat message from the first external router and the second external router to identify a connection status with the first external router and the second external router.

The method may include an operation of switching a data path from the first external router to the second external router when the first heartbeat message is not received from the first external router and an operation of controlling to perform the SCTP data communication between the client and the endpoint from the second external router.

The first external router and the second external router are connected to one node of the electronic device to configure SCTP multi-homing.

The first external router may be connected to a first node of the electronic device and the second external router may be connected to a second node of the electronic device.

The first node and the second node are formed as a cluster of the electronic device to configure the SCTP multi-homing.

The operation of translating the first IP address into a first IP translation address and the second IP address into a second IP translation address may be performed in a FullNAT mode.

An operation of advertising the first IP translation address or the second IP translation address to the endpoint may use BGP.

The electronic device is combined with the Kubernetes to support the multi-homing.

An SCTP multi-homing system including a client, a first external router, a second external router, an electronic device, and an endpoint according to various exemplary embodiments may include an operation of establishing SCTP connection by the client and the electronic device through a first IP address via a first external router and a second IP address via a second external router, an operation of translating the first IP address into a first IP translation address and the second IP address into a second IP translation address, by the electronic device, an operation of advertising the first IP translation address or the second IP translation address to the client and the endpoint, by the electronic device, and an operation of performing SCTP data communication between the client and the endpoint.

1. A method of an electronic device, comprising:
an operation of establishing SCTP connection through a first IP address via a client and a first external router and a second IP address via a second external router;
an operation of translating the first IP address into a first IP translation address and the second IP address into a second IP translation address; and
an operation of advertising the first IP translation address or the second IP translation address to an endpoint to control to perform SCTP data communication between the client and the endpoint.

2. The method of an electronic device according to claim 1, wherein the electronic device includes an operation of receiving a first heartbeat message and a second heartbeat message from the first external router and the second external router to identify a connection status with the first external router and the second external router.

3. The method of an electronic device according to claim 2, further comprising:
an operation of switching a data path from the first external router to the second external router when the first heartbeat message is not received from the first external router; and
an operation of controlling to perform the SCTP data communication between the client and the endpoint from the second external router.

4. The method of an electronic device according to claim 3, wherein the first external router and the second external router are connected to one node of the electronic device to configure SCTP multi-homing.

5. The method of an electronic device according to claim 3, wherein the first external router is connected to a first node of the electronic device and the second external router is connected to a second node of the electronic device.

6. The method for an electronic device according to claim 5, wherein the first node and the second node are formed as a cluster of the electronic device to configure the SCTP multi-homing.

7. The method of an electronic device according to claim 6, wherein the operation of translating the first IP address into a first IP translation address and the second IP address into a second IP translation address is performed in a FullNAT mode.

8. The method of an electronic device according to claim 7, wherein an operation of advertising the first IP translation address or the second IP translation address to the endpoint uses BGP.

9. The method for an electronic device according to claim 8, wherein the electronic device is combined with Kubernetes to support multi-homing.

10. An SCTP multi-homing system including a client, a first external router, a second external router, an electronic device, and an endpoint, comprising:
an operation of establishing SCTP connection by the client and the electronic device through a first IP address via a first external router and a second IP address via a second external router;
an operation of translating the first IP address into a first IP translation address and the second IP address into a second IP translation address, by the electronic device;
an operation of advertising the first IP translation address or the second IP translation address to the client and the endpoint, by the electronic device; and
an operation of performing SCTP data communication between the client and the endpoint.
